(19) United States
(12) Patent Application Publication
(10) Pub. No.: US 2025/0334675 A1
(43) Pub. Date: Oct. 30, 2025

(54) OBJECT DETECTION SYSTEM AND OBJECT DETECTION METHOD

(71) Applicant: Mitsubishi Electric Corporation, Tokyo (JP)

(72) Inventor: Masashi FUKUNAGA, Tokyo (JP)

(73) Assignee: Mitsubishi Electric Corporation, Tokyo (JP)

(21) Appl. No.: 19/263,193

(22) Filed: Jul. 8, 2025

Related U.S. Application Data
(63) Continuation of application No. PCT/JP2023/007410, filed on Feb. 28, 2023.

(51) Int. Cl. G01S 7/48; G01S 7/481

(52) U.S. Cl. CPC G01S 7/4804; G01S 7/4815

(57) ABSTRACT

A laser sensor (110) includes a first main laser (111) to emit laser light of a first wavelength, a second main laser (112) to emit laser light of a second wavelength, a dummy laser (113) to emit laser light of a third wavelength, a first light-receiving element (114) sensitive to light of the first wavelength, and a second light-receiving element sensitive to light of the second wavelength. The first main laser and the second main laser alternately emit the laser light.

### CROSS REFERENCE TO RELATED APPLICATION

This application is a Continuation of PCT International Application No. PCT/JP2023/007410, filed on Feb. 28, 2023, which is hereby expressly incorporated by reference into the present application.

### TECHNICAL FIELD

The present disclosure relates to object detection using lasers.

### BACKGROUND ART

Measurement using LiDAR includes measurement using the ToF principle.

LiDAR is an abbreviation for light detection and ranging.

ToF is an abbreviation for time of flight.

Measurement using the ToF principle refers to a method of calculating a distance based on a time period from when laser light is emitted until the laser light that is reflected after hitting a subject (reflected light) is received by a sensor.

LiDARs mainly employ near-infrared light with a wavelength of 903 nanometers or 905 nanometers. A LIDAR with a wavelength of 1550 nanometers has also been developed. The longer the wavelength, the further the measurement can reach.

In a 900-nanometer LiDAR, silicon (Si) is used as a light-receiving element.

In a 1550-nanometer LiDAR, indium gallium arsenide (InGaAs) is used as a light-receiving element.

One known attack against infrared sensors that measure the surrounding environment, such as a LiDAR, is a spoofing attack using a fake reflection wave. Countermeasures against this spoofing attack include redundancy and sensor fusion.

However, one known attack against self-driving cars is an attack that deceives processing of object detection signals of sensor fusion using a camera and a LiDAR.

Therefore, it is important to implement not only countermeasures by sensor fusion using multiple sensors, but also countermeasures against attacks on individual sensors.

Known countermeasures against attacks on sensors include random modulation, adoption of multiple wavelengths, and narrowing a light-receiving angle.

Although random modulation FMCW LiDARs have been developed, rotation is difficult, resulting in a narrow measurement range. To carry out 360-degree measurement, multiple LiDARs are required, making it unsuitable for compact devices like drones.

Adopting multiple wavelengths allows for cost-effective attacks for attackers by using multiple wavelengths.

Narrowing the light-receiving angle can reduce room for attacks. However, it is necessary to install multiple LiDARs, which is costly. There are use cases where a cost-effective sensor attack countermeasure is required without increasing the number of LiDARs.

Patent Literature 1 discloses a countermeasure against deceptive attacks on sensors. This countermeasure involves preparing deceptive signals and causing an attacker to believe that the deceptive signals are true measurement signals and attack the deceptive signals.

### CITATION LIST

### Patent Literature

Patent Literature 1: JP H9-281397 A

### SUMMARY OF INVENTION

### Technical Problem

Conventional countermeasures against spoofing attacks require multiple LiDARs and cannot be applied to small devices like UAVs. Additionally, financial and technical costs are incurred.

UAV is an abbreviation for unmanned aerial vehicle.

No countermeasures have been proposed against attacks that deceive signal processing of sensor fusion.

An object of the present disclosure is to prevent incorrect object detection under the influence of a spoofing attack.

### Solution to Problem

A laser sensor of the present disclosure includes

a main laser to emit laser light of a specific wavelength;

a dummy laser to emit laser light of a wavelength different from the specific wavelength; and

a light-receiving element sensitive to light of the specific wavelength.

### ADVANTAGEOUS EFFECTS OF INVENTION

According to the present disclosure, it is possible to prevent incorrect object detection under the influence of a spoofing attack.

### BRIEF DESCRIPTION OF DRAWINGS

FIG. 1 is a configuration diagram of an object detection system 100 in Embodiment 1.

FIG. 2 is a configuration diagram of a laser sensor 110 in Embodiment 1.

FIG. 3 is a configuration diagram of an attack detection device 120 in Embodiment 1.

FIG. 4 is a configuration diagram of an object detection device 130 in Embodiment 1.

FIG. 5 is a functional configuration diagram of the object detection system 100 in Embodiment 1.

FIG. 6 is a flowchart of an object detection method in Embodiment 1.

FIG. 7 is a flowchart of the object detection method in Embodiment 1.

### DESCRIPTION OF EMBODIMENTS

In the embodiment and drawings, the same elements or corresponding elements are denoted by the same reference sign. Description of an element denoted by the same reference sign as that of an element that has been described will be suitably omitted or simplified. Arrows in diagrams mainly indicate flows of signals, data, or processing.

### Embodiment 1

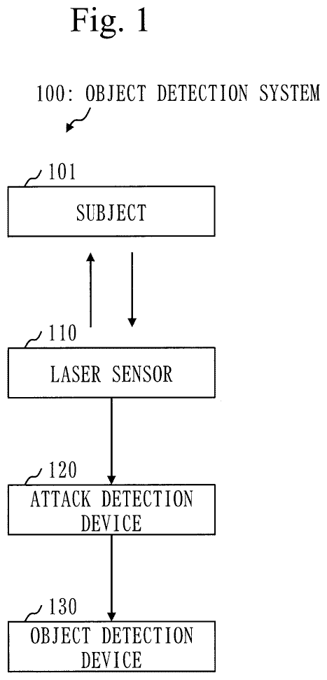

An object detection system 100 will be described based on FIGS. 1 to 7.

### Description of Configuration

Based on FIG. 1, a configuration of the object detection system 100 will be described.

The object detection system 100 is a system that uses a laser sensor 110 to detect a subject 101.

The subject 101 is an object to be detected. In other words, the subject 101 is a target to be sensed.

The object detection system 100 includes a laser sensor 110, an attack detection device 120, and an object detection device 130.

Specifically, the laser sensor 110 is a LiDAR. The LiDAR is an infrared sensor. The attack detection device 120 and the object detection device 130 are computers.

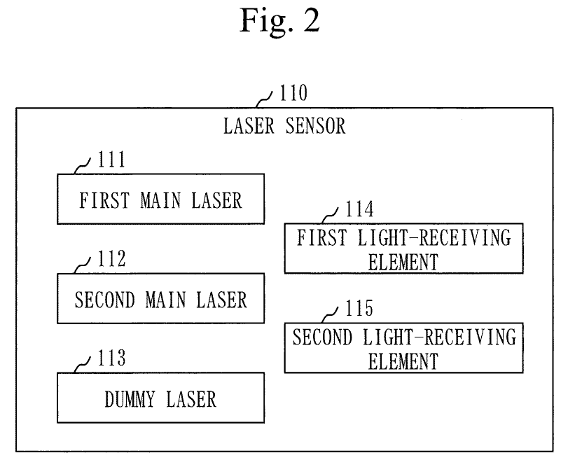

Based on FIG. 2, a configuration of the laser sensor 110 will be described.

The laser sensor 110 includes three types of lasers (111, 112, 113).

A first main laser 111 and a second main laser 112 are lasers for measurement, and emit laser light of mutually different wavelengths.

The first main laser 111 emits laser light of a first wavelength. Specifically, the first main laser 111 emits laser light of about 900 nanometers.

The second main laser 112 emits laser light of a second wavelength. Specifically, the second main laser 112 emits laser light of about 1550 nanometers.

A dummy laser 113 emits laser light of a third wavelength. The third wavelength is a wavelength between the first wavelength and the second wavelength. Specifically, the dummy laser 113 emits laser light of about 1000 nanometers.

The laser sensor 110 includes two types of light-receiving elements (114, 115).

A first light-receiving element 114 is a light-receiving element sensitive to light of the first wavelength. Specifically, the first light-receiving element 114 is a light-receiving element that uses a semiconductor of silicon (Si).

A second light-receiving element 115 is a light-receiving element sensitive to light of the second wavelength. Specifically, the second light-receiving element 115 is a light-receiving element that uses a compound semiconductor of indium gallium arsenide (InGaAs).

The laser sensor 110 has a mechanism to rotate all of the three types of lasers (111, 112, 113) and the two types of light-receiving elements (114, 115) in order to perform measurement over a wide surrounding area.

For example, the laser sensor 110 has a rotation mechanism to carry out measurement in a 360-degree surrounding area. The rotation mechanism rotates all of the three lasers and the two light-receiving elements 360 degrees.

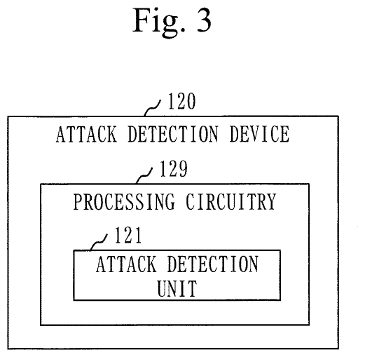

Based on FIG. 3, a configuration of the attack detection device 120 will be described.

The attack detection device 120 includes hardware called processing circuitry 129.

The attack detection device 120 includes an element called an attack detection unit 121.

The processing circuitry 129 is hardware that realizes the attack detection unit 121.

The processing circuitry 129 may be dedicated hardware or may be a processor that executes programs stored in a memory.

The dedicated hardware is, for example, a single circuit, a composite circuit, a programmed processor, a parallel-programmed processor, an ASIC, an FPGA, or a combination of these.

ASIC is an abbreviation for application specific integrated circuit.

FPGA is an abbreviation for field programmable gate array.

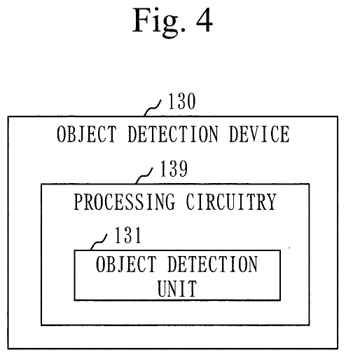

Based on FIG. 4, a configuration of the object detection device 130 will be described.

The object detection device 130 includes hardware called processing circuitry 139.

The object detection device 130 includes an element called an object detection unit 131.

The processing circuitry 139 is hardware that realizes the object detection unit 131.

The processing circuitry 139 may be dedicated hardware or may be a processor that executes programs stored in a memory.

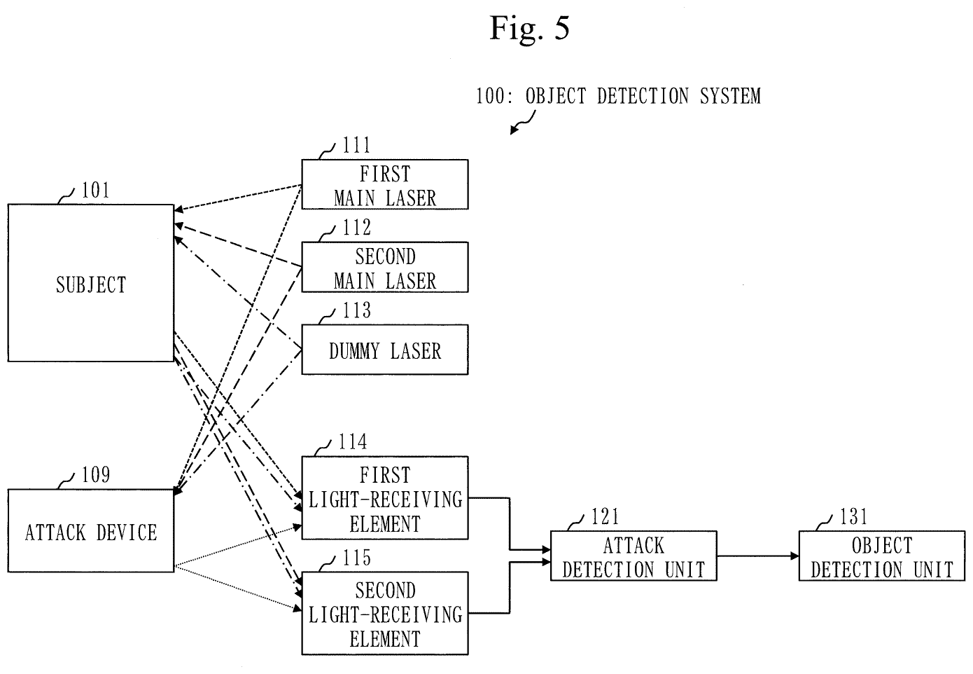

FIG. 5 illustrates relationships among the elements in the object detection system 100.

The three types of lasers (111, 112, 113) emit laser light. Note that the two types of main lasers (111, 112) alternately emit laser light.

The two types of light-receiving elements (114, 115) receive (detect) laser light reflected by the subject 101 and output received-light signals.

Receiving light means to receive light and convert the received light into an electrical signal.

Detecting means to regard an electrical signal as point cloud data. When the amount of light is greater than a threshold, an electrical signal is regarded as point cloud data. Electrical signals that are not regarded as point cloud data are discarded as unnecessary data.

A received-light signal is an electrical signal obtained by receiving and detecting light, and represents laser light.

The attack detection unit 121 receives received-light signals, detects an attack by the attack device 109, and outputs received-light signals that are not under attack.

The object detection unit 131 processes received-light signals that are not under attack so as to detect the subject 101.

The attack device 109 is a device that carries out a spoofing attack.

The attack device 109 detects laser light emitted from the three types of lasers, and emits laser light for interference.

### Description of Operation

A procedure for the operation of the object detection system 100 is equivalent to an object detection method.

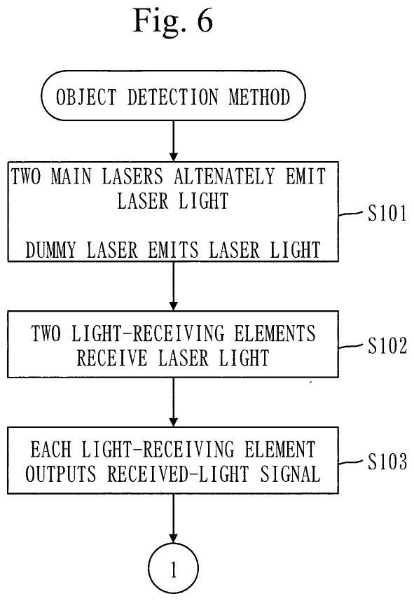

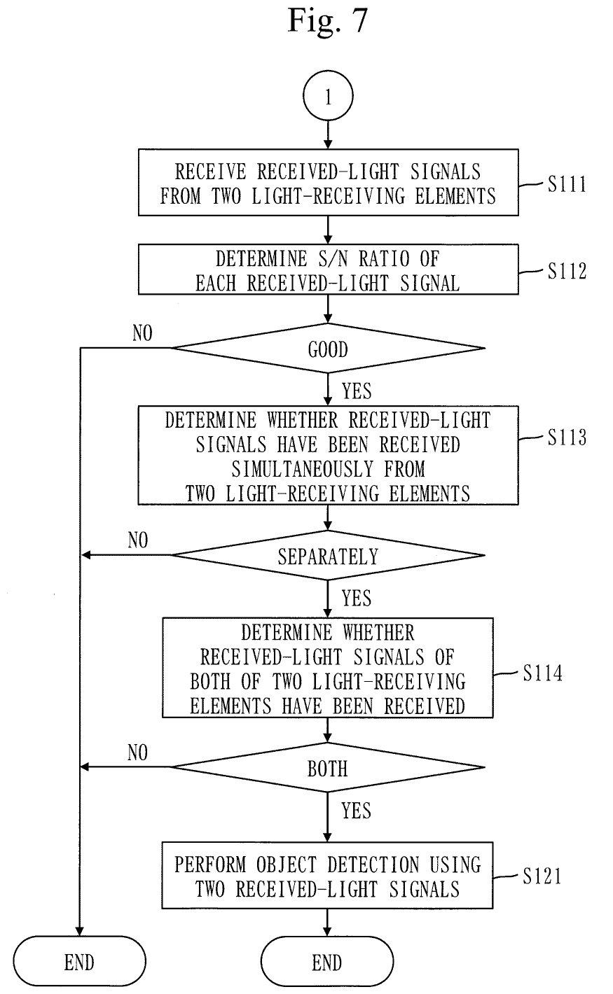

Based on FIGS. 6 and 7, the object detection method will be described.

Based on FIG. 6, the operation of the laser sensor 110 in the object detection method will be described.

In step S101, the first main laser 111 and the second main laser 112 alternately emit laser light. In addition, the dummy laser 113 continues to emit laser light.

The first main laser 111 emits laser light of the first wavelength. The laser light of the first wavelength is referred to as first laser light.

The second main laser 112 emits laser light of the second wavelength. The laser light of the second wavelength is referred to as second laser light.

The dummy laser 113 emits laser light of the third wavelength. The laser light of the third wavelength is referred to as dummy laser light.

Each of the first laser light, the second laser light, and the dummy laser light reflects when hitting the subject 101.

Upon detecting the first laser light, the second laser light, or the third laser light, the attack device 109 emits laser light for interference. The laser light for interference is referred to as attack laser light.

In step S102, the first light-receiving element 114 and the second light-receiving element 115 receive laser light.

The first light-receiving element 114 detects the first laser light. If the wavelength of the attack laser light is close to the first wavelength, the first light-receiving element 114 detects both the first laser light and the attack laser light. On the other hand, the second laser light and the dummy laser light are not detected by the first light-receiving element 114.

The second light-receiving element 115 detects the second laser light. If the wavelength of the attack laser light is close to the second wavelength, the second light-receiving element 115 detects both the second laser light and the attack laser light. On the other hand, the first laser light and the dummy laser light are not detected by the second light-receiving element 115.

In step S103, the first light-receiving element 114 and the second light-receiving element 115 output received-light signals.

The received-light signal output from the first light-receiving element 114 is referred to as a first received-light signal.

The received-light signal output from the second light-receiving element 115 is referred to as a second received-light signal.

Based on FIG. 7, the operation of the attack detection device 120 and the object detection device 130 in the object detection method will be described.

In step S111, the attack detection unit 121 receives the received-light signals from the first light-receiving element 114 and the second light-receiving element 115.

In step S112, the attack detection unit 121 determines an S/N ratio of each of the received-light signals that have been received. The S/N ratio means the signal-to-noise ratio.

The S/N ratio of the received-light signal is determined as follows.

First, the attack detection unit 121 calculates the S/N ratio of the received-light signal.

Then, the attack detection unit 121 compares the S/N ratio with a threshold.

If the S/N ratio is equal to or greater than the threshold, the attack detection unit 121 determines that the S/N ratio is good.

If the S/N ratio is less the threshold, the attack detection unit 121 determines that the S/N ratio is poor.

If the S/N ratio is good, the process proceeds to step S113.

If the S/N ratio is poor, the received-light signal is considered to be the signal of the dummy laser light. Therefore, the received-light signal is eliminated as an unnecessary point cloud. That is, the received signal is eliminated as an electrical signal not to be turned into point cloud data. Then, the process ends without performing object detection.

In step S113, the attack detection unit 121 determines whether the first received-light signal from the first light-receiving element 114 and the second received-light signal from the second light-receiving element 115 have been received simultaneously.

If the first received-light signal and the second received-light signal have not been received simultaneously, the process proceeds to step S114.

If the first received-light signal and the second received-light signals have been received simultaneously, one of the received-light signals is considered to be an attack signal. Therefore, the received-light signal is processed as a false reflection wave. This means that even though the received-light signal is valid point cloud data, it is an attack signal and thus the point cloud is removed to prevent it from affecting a subsequent application. The subsequent application means, for example, processing by the processing circuitry 139. Then, the process ends.

In step S114, the attack detection unit 121 determines whether both the first received-light signal from the first light-receiving element 114 and the second received-light signal from the second light-receiving element 115 have been received.

If both the first light-receiving signal and the second received-light signal have been received, the attack detection unit 121 outputs each of the first light-receiving signal and the second received-light signal. Then, the process proceeds to step S121.

If at least one of the first received-light signal and the second received-light signal has not been received, the received-light signal that has been received is considered to be an attack signal. Therefore, the process ends without performing object detection.

In step S121, the object detection unit 131 receives each of the first received-light signal and the second received-light signal.

Then, the object detection unit 131 performs object detection using at least one of the first received-light signal and the second received-light signal. As a result, the subject 101 is detected.

The following processing is performed in object detection.

The object detection unit 131 calculates a relative distance at a measurement time point based on flight time of laser light.

The relative distance is a distance from the laser sensor 110 to the subject 101, and is calculated by multiplying the speed of light by the flight time.

The flight time is time from when the laser light is emitted until the laser light is received (detected). The flight time is measured based on the number of clocks in an internal circuit, for example.

The measurement time point is the time point when the laser light is emitted or the time point when the laser light is received (detected).

After step S121, the process ends.

Step S101 to Step S121 are executed repeatedly.

### Effects of Embodiment 1

Embodiment 1 enables countermeasures against deception attacks on sensors and advanced attacks such as those that deceive sensor fusion.

Embodiment 1 makes it possible to significantly reduce the deception attack capability of an attacker. The attacker can newly establish a mechanism for eliminating signals with a poor S/N ratio. However, an attack that overcomes sensor fusion requires inserting a point cloud into a specific location, and is difficult to realize when the freedom in the attack is reduced. Moreover, since the attacker needs to newly add a mechanism in addition to an attack mechanism, an increase in the attacking cost of the attacker is expected.

### Summary of Embodiment 1

In the following description, parentheses are attached to elements that correspond to the elements of Embodiment 1, and the reference signs of the elements of Embodiment 1 are indicated in the parentheses.

An infrared sensor (110) is characterized by its configuration and detection signal processing.

A laser (111) of about 900 nm and a laser (112) of about 1550 nm alternately emit light. Note that at the timing when laser light of about 900 nm is emitted, laser light of about 1550 nm is received, but is not processed as a point cloud. Similarly, at the timing when laser light of about 1550 nm is emitted, laser light of about 900 nm is received, but is not processed as a point cloud.

Laser light of about 1000 nm is emitted, but is treated as dummy light that is not received as light. An Si light-receiving element (114) and an InGaAs light-receiving element (115) react to light with a wavelength of about 1000 nm, but the S/N ratio of this signal is poor. For this reason, the signal of light with a wavelength of about 1000 nm is eliminated in the stage of point cloud formation processing.

Signal processing for attack detection distinguishes between true reflection waves and false reflection waves (signals by an attacker).

First, if light of the same wavelength arrives from the same position in each of alternating measurements, the arrived light is considered to be a false reflection wave. This can prevent laser emitting attacks using one of a wavelength of about 900 nm and a wavelength of about 1550 nm.

Next, if light from the laser (111) of about 900 nm and light from the laser (112) of about 1550 nm arrive simultaneously, the arrived light is considered to be a false reflection wave. This is because light of about 900 nm and light of about 1550 nm are emitted alternately, so that only one of these types of light is normally detected at a time. Even if the attacker prepares a laser emitting attack device (109) that supports both of the wavelengths, a light-receiving mechanism of the attacker reacts to dummy light of about 1000 nm, causing the laser emitting attack device to emit laser light of both of the wavelengths. This allows an attack to be detected. This is because the attacker does not have a signal processing mechanism to eliminate signals with a poor S/N ratio.

Embodiment 1 is characterized in that dummy light to which the light-receiving elements (114, 115) have low measurement sensitivity is used.

By using light that can be measured as dummy light instead of using completely invisible light as dummy light, it is possible to provoke an attack from the attacker and eliminate false signals.

### Supplement to Embodiment 1

The received-light signals output from the attack detection unit 121 are used for object detection and mapping of the surrounding environment based on a collection of point clouds, for example.

For an attack that overcomes sensor fusion to be executed, it is not sufficient to simply emit light, but it is necessary to emit light in such a way that a specific location and point clouds in a specific pattern appear. For example, the specific location is behind an obstacle such as a car. For example, the specific pattern is positioning light so that point clouds appear to form a cone. It is difficult to direct light at a moving object, and execution of an ingenious attack requires a high degree of freedom in the attack (few conditions for the attack to be successful). Therefore, reducing the degree of freedom in the attack makes it difficult to realize the attack.

Embodiment 1 is an example of a preferred embodiment and is not intended to limit the technical scope of the present disclosure. Embodiment 1 may be implemented partially, or may be implemented in combination with other embodiments.

The laser sensor 110 may be without one of the first main laser 111 and the second main laser 112.

The attack detection device 120 and the object detection device 130 may be realized as a single device.

The procedures described using the flowcharts or the like may be suitably modified.

The order of step S112, step S113, and step S114 may be interchanged.

“Unit” of each element of the attack detection device 120 and the object detection device 130 may be interpreted as “process”, “step”, “circuit”, or “circuitry”.

The programs can be recorded (stored) in a computer readable format in a non-volatile recording medium, such as an optical disc or a flash memory.

### REFERENCE SIGNS LIST

100: object detection system; 101: subject; 109: attack device; 110: laser sensor; 111: first main laser; 112: second main laser; 113: dummy laser; 114: first light-receiving element; 115: second light-receiving element; 120: attack detection device; 121: attack detection unit; 129: processing circuitry; 130: object detection device; 131: object detection unit; 139: processing circuitry.

1. An object detection system comprising:
a first main laser to emit laser light of a first wavelength and a second main laser to emit laser light of a second wavelength, the first main laser and the second main laser alternately emitting the laser light;
a dummy laser to emit laser light of a third wavelength;
a first light-receiving element sensitive to light of the first wavelength, the first light-receiving element detecting laser light and outputting a first received-light signal, which is a signal of the detected laser light;
a second light-receiving element sensitive to light of the second wavelength, the second light-receiving element detecting laser light and outputting a second received-light signal, which is a signal of the detected laser light;
processing circuitry to receive the first received-light signal that has been output and the second received-light signal that has been output, determine a signal-to-noise ratio of each of the first received-light signal that has been received and the second received-light signal that has been received, and determine whether the first received-light signal and the second received-light signal have been received simultaneously; and
processing circuitry to perform object detection when it is not determined that the first received-light signal and the second received-light signal have been received simultaneously, the object detection being performed using at least one of the first received-light signal whose signal-to-noise ratio is determined to be good and the second received-light signal whose signal-to-noise ratio is determined to be good.

2. An object detection method comprising:
emitting laser light of a first wavelength and laser light of a second wavelength alternately;
emitting laser light of a third wavelength;
having sensitivity to light of the first wavelength, detecting laser light, and outputting a first received-light signal, which is a signal of the detected laser light;
having sensitivity to light of the second wavelength, detecting laser light, and outputting a second received-light signal, which is a signal of the detected laser light;
receiving the first received-light signal that has been output and the second received-light signal that has been output, determining a signal-to-noise ratio of each of the first received-light signal that has been received and the second received-light signal that has been received, and determining whether the first received-light signal and the second received-light signal have been received simultaneously; and
performing object detection when it is not determined that the first received-light signal and the second received-light signal have been received simultaneously, the object detection being performed using at least one of the first received-light signal whose signal-to-noise ratio is determined to be good and the second received-light signal whose signal-to-noise ratio is determined to be good.
